(19) United States
(12) Patent Application Publication
(10) Pub. No.: US 2007/0292599 A1
(43) Pub. Date: Dec. 20, 2007

(54) Method for determining a required paint quantity

(75) Inventors: Dietmar Eickmeyer, Friedberg (DE); Jurgen Kristen, Langgons (DE)

Correspondence Address: BUCHANAN, INGERSOLL & ROONEY PC, POST OFFICE BOX 1404, ALEXANDRIA, VA, 22313-1404, US

(73) Assignee: ABB Patent GmbH, Ladenburg (DE)

(21) Appl. No.: 11/806,225

(22) Filed: May 30, 2007

(30) Foreign Application Priority Data
May 31, 2006 (DE) 10 2006 026 051.1

(51) Int. Cl. C23C 16/52

(52) U.S. Cl. 427/8

(57) ABSTRACT

A method for determining a required paint quantity and use of the method to operate paint-spraying robots are disclosed. In an exemplary method for determining a required paint quantity for the paint-spraying operation of a paint-spraying robot, in an integration operation, from the motional sequence of the paint-spraying robot and the paint-spraying parameters, an integration value for the paint quantity is determined. A correction factor is determined, from the integration value and the correction factor. A start value is formed. The start value is fed to an adaptive system. The method has the advantage that the learning phase for an adaptive system can be shortened and paint losses diminished.

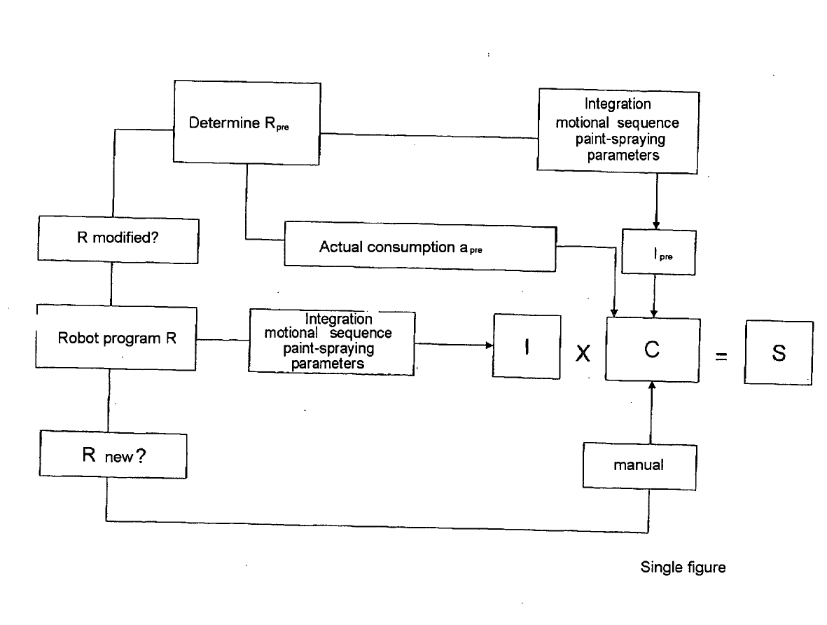

### RELATED APPLICATIONS

This application claims priority under 35 U.S.C. §119 to German Application 10 2006 026 051.1 filed in Germany on May 31, 2006, the entire contents of which are hereby incorporated by reference in their entireties.

### TECHNICAL FIELD

Method for determining a required paint quantity and use of the method to operate paint-spraying robots are disclosed. An exemplary method for determining a required paint quantity for the paint-spraying operation of a paint-spraying robot, as well as the use of the method to operate paint-spraying robots, is defined.

### BACKGROUND INFORMATION

It is generally known to set by hand the paint quantity which is required for a specific paint-spraying operation when operating a paint-spraying robot. This setting is generally based on a rough estimate of the paint consumption and a high safety factor must accordingly be factored in to ensure that the robots are supplied with paint throughout the paint-spraying operation.

### SUMMARY

A method is disclosed for determining a required paint quantity for the paint-spraying operation of a paint-spraying robot, in which it is possible to work with a low safety factor. For example, a method is disclosed for determining a required paint quantity for the paint-spraying operation of a paint-spraying robot, comprising the following steps: a) in an integration operation, from the motional sequence of the paint-spraying robot and the paint-spraying parameters, an integration value (I) for the paint quantity is determined, b) a correction factor (C) is determined, c) from the integration value (I) and the correction factor (C), a start value (S) is formed, d) the start value (S) is fed to an adaptive system.

### BRIEF DESCRIPTION OF THE DRAWING

An exemplary embodiment of the method for determining the paint quantity is illustrated in greater detail in the FIGURE as provided.

### DETAILED DESCRIPTION

According to one exemplary embodiment of the method, it is provided that the planned motional sequence of the paint-spraying robot is used together with the paint-spraying parameters of the paint-spraying robot to determine an integration value for the required paint quantity.

According to one exemplary embodiment, it is further provided that a correction factor for the integration value is determined.

In a further method step, from the integration value and the correction factor a start value can be formed as the basis for the start of an adaptive system.

The described exemplary method can be applied particularly advantageously in industrial paint-spraying practice, where the variety of shapes and the complexity of the parts to be paint-sprayed is constantly increasing, whilst, at the same time, the paint colour variety is expanding. The exemplary method is suitable for use, in particular, for automatic paint-spraying robots. Both the high variety of options for the geometries and the high number of customer-specific paints, which are sometimes paint-sprayed only a few times a year, show that there is a high individuality factor for the paint-sprayed parts and identical paint-spraying operations are only very rarely performed in large number.

The described exemplary method can be used particularly advantageously where the paint colours of the paint-spraying robot have to be changed, since, in particular, the changeover between two paint colours leads inevitably to paint losses. With the aid of the here described exemplary method, it is possible to reduce paint losses by using for a paint-spraying operation a paint quantity which has previously been calculated as precisely as possible.

For the prior calculation of the required paint quantity, in particular an integration operation may be considered in which, on the basis of the predefined program of movement of the robot, a calculation of the paint quantity is performed in advance. By means of an integration operation, a theoretical value of the total paint consumption is in this case determined from the respective desired paint discharge quantity and the movement or moving time of the paint robot.

For example, at constant discharge rate, i.e. paint discharge per unit of time, this can be easily multiplied by the moving time of the paint robot. In other cases, the time-dependent discharge rate can be integrated via the movement of the paint robot.

In this integration operation, only the desired motional value of the robot can be taken into account. In particular, no regard is given to variances from the desired motional values on curves or reorientation points of the robot. These variances arise from the fact that the robot only has a finite acceleration capability. The length of the paint application and thus also the consumption value determined therefrom is hence subjected to an error, which error is counterbalanced, however, by the fact that the calculation, which is based solely on the desired motional values of the robot, can be very simply formulated and performed with little computing effort and time expenditure.

In order to compensate at least partially for the disregard of the kinematics of the robot in the integration process and in determining the theoretical paint consumption, according to the here described exemplary method a correction factor is determined, from which, together with the integration value, a start value for an adaptive system is determined.

As the adaptive system, a system based on at least one artificial neuronal network may be considered, for example, which system, with the aid of a learning phase, can determine from a start value for a required paint quantity a precisely calculated required paint quantity. Given the identical geometric shape and the identical colour to be paint-sprayed, an adaptive system of this kind determines in a representative number of paint-spraying operations the respectively actually required paint quantity and uses this value as the starting basis for the required paint quantity of the next part of identical shape and colour. For this exemplary method, some actually performed paint-spraying operations are necessary in order to determine the precisely calculated paint consumption for the respective combination of a geometric shape with a specific paint colour. The more precisely is determined the start value for the adaptive system, the less paint is lost in the learning phase of the adaptive system, since the number of actual paint-spraying runs can thereby be reduced.

With the aid of the here described exemplary method, as precise as possible a start value for the required paint quantity is precalculated without actual paint-spraying runs having to be performed for one and the same paint-spraying operation and the paint losses during the learning phase of the adaptive system can be minimized. Without the use of the here described exemplary method, as the initial start value for the adaptive system an estimated value with a very high safety premium would have to be used, which would increase both the number of actual paint-spraying runs for the learning operation and also the paint losses.

According to one exemplary embodiment of the method, prior to the formation of the start value, a decision is made which relates the current paint-spraying operation to preceding paint-spraying operations. A differentiation is here made between two cases:
i) The current paint-spraying operation is merely a modification of some preceding paint-spraying operation.
ii) The current paint-spraying operation is a new paint-spraying operation and does not constitute the modification of some preceding paint-spraying operation.

According to this exemplary embodiment of the method, a differentiation is therefore made according to the extent to which the paint-spraying operation merely constitutes a modification of some preceding paint-spraying operation, or not. Regard should here be given to the fact that, in a paint-spraying line which is used in practice, the operators responsible for this frequently make parameter changes for the paint-spraying operation, which, although they alter the paint-spraying operation relative to a previous version of the paint-spraying operation, nevertheless produce only a slightly revised variant.

Parameter changes can particularly become necessary when in the course of the paint-spraying defects arise, such as, for example, a slight undercoating in the door sill region of motor vehicles, the cause of which is attributable, for example, to a variation in paint load, seasonal climatic changes or the introduction of a new paint colour. Since for time reasons, in the production line during the production, there is no opportunity to more closely examine the causes of the fault, such faults are usually remedied as quickly as possible by, for example, the delivery of an increased paint quantity to the appropriate defects. However, this leads disadvantageously to an increased overall consumption.

In case ii, a manually determined value can be used as the correction factor. Here, the appropriate correction factor is determined and/or registered manually, for example by the plant operator, on the basis of empirical data and/or in a control-based manner. A comparatively high correction factor can here initially be specified and then, iteratively, the next paint-spraying quality-checked and the correction factor, where necessary, adapted until the desired paint quality is achieved and the optimal value of the correction factor determined.

If situation i pertains, the knowledge of the preceding paint-spraying operation can advantageously be used to determine the correction factor. This does not necessarily have to relate to the directly preceding paint-spraying operation, but rather a predating paint-spraying operation may also be considered. It is merely important that the precursor paint-spraying operation and the current paint-spraying operation differ as little as possible from each other and can be switched from one to the other simply through minor parameter changes.

Once the precursor paint-spraying operation is determined, then the information on the precursor paint-spraying operation can be used to determine the correction factor. In particular, in order to determine the correction factor, the actually required paint quantity of the precursor paint-spraying operation can be used. Advantageously, in the course of an exemplary application of the method, the actually required paint quantities of all paint-spraying operations are stored in a suitable database, so that these can be consulted at all times for the calculation of correction factors.

Furthermore, in addition to the actually required paint quantity of the preceding paint-spraying operation, the paint quantity for the preceding paint-spraying operation calculated in an integration step may also be used for determining the correction factor. In principle, the same integration method can be used here as is used for the current paint-spraying operation. Either the integration value of the preceding paint-spraying operation is calculated following determination of the same, or the calculated value is already present in the associated database.

The actually required paint quantity of the preceding paint-spraying operation and the calculated paint quantity acquired in the integration step can be used to form a quotient, which is multiplied by the integration value calculated for the current paint-spraying program.

Thus the experience gained from a similar paint-spraying operation concerning the variance between the paint quantity calculated by simple integration and the actually required paint quantity can be used to determine the paint quantity which is likely to be required for a new paint-spraying operation.

In general, the actually required paint quantity will vary from the paint quantity calculated in the integration step, so that as the correction value a value is obtained which is either greater or less than 1.

In addition, in a further exemplary embodiment of the method, particular regard can also be given to the uncertainty which derives from the disregard of the kinematics in the integration step. For example, the uncertainty factor can be compensated by the fact that, for this, an empirical value arising from preceding calculations with due regard to the kinematics, or even from trials, can be applied.

The uncertainty factor of the kinematics stems, in particular, from the fact that the robot is not always capable of maintaining the desired speed, but rather, in the event of a change of motional direction, reorientation, acceleration and deceleration, generally acts more slowly than is sought. It also therefore travels and/or moves slower on average, which, at constant paint spraying rate, leads to increased paint consumption. The respectively required paint quantity or its variance from the desired consumption depends, in turn, on the robot movement—if, for example, a motor interior is being paint-sprayed, the robot must very frequently reorientate and will deviate more strongly from the desired value than, for example, in the case of an external paint-spraying in which essentially rectangular paths are travelled. This correction factor is also therefore robot-program-related.

The here described exemplary method can advantageously be used, above all, in paint-spraying systems which allow a potential separation of the paint. A potential separation is required when water-based paint is used, wherein the paint is set at a high-voltage potential in order to increase the coating efficiency. This has the effect that paint particles from the paint mist formed during the application are deposited on the earthed object to be paint-sprayed and thus the coating efficiency is increased.

The use of the exemplary method may be particularly considered for operating a paint-spraying robot containing filled paint cartridges. In a cartridge solution of this kind, the atomizer of the robot, prior to the application, is supplied with a paint tank containing a maximum, fixedly predefined volume of paint material. This volume can be calculated by means of the here described exemplary method. The filling of the cartridge is effected by a separate system, in a state where there is no paint-spraying. There can either be a plurality of cartridges in alternate use, or even just a single cartridge which is prepared by an extremely rapid filling operation for the respectively next paint-spraying operation. The advantage of such an arrangement lies in the fact that, on the one hand, the potential separation is securely realized by the mechanical separation of the cartridge holder from the filling station and, on the other hand, the number of usable paints can be increased.

In another exemplary embodiment it is possible to use the here described exemplary method to operate a paint-spraying robot containing a paint pipeline divided by stoppers. In this so-called pig solution, a specific volume of paint is forced out of the paint-mixing chamber of the paint-spraying plant into the paint pipeline leading to the robot. This volume shall be chosen such that at least the paint quantity required for the respective paint-spraying operation is contained in the pipeline as a paint column. The end of the paint column is formed by a so-called pig, i.e. a type of cork having exactly the internal diameter of the pipe. Following on from the paint column for the one paint colour, the next paint colour—again separated by pig—can already be filled in the pipeline in the desired quantity. The existing pigs can also, in particular, perform the task of electrical insulation and thus allow a potential separation.

The exemplary method for determining the paint quantity is explained in greater detail below with reference to the figure.

For a current robot program R corresponding to a specific paint-spraying operation, an integration value I is determined by an integration process which takes into account both the motional sequence and the paint-spraying parameters of the robot program, yet in which no regard is given to the kinematics.

Moreover, a decision is made on whether the current robot program R is a completely new robot program or whether it constitutes the modification of a precursor robot program Rₚᵣₑ. Where the robot program in question is new, a manual correction factor C is determined, which, when multiplied by the integration factor, forms the start value S for the adaptive system.

Where the current robot program R constitutes a modified robot program, the precursor robot program Rₚᵣₑ closest to the current robot program R is determined. In the simplest case, the precursor robot program is determined as the immediately preceding program. Once the precursor robot program, i.e., therefore, the preliminary version of the current robot program R, is obtained, an integration value Iₚᵣₑ is determined from a calculation as was correspondingly performed for the current robot program R. That is to say, the calculation is made with due regard to motional sequence and paint-spraying parameters, yet without kinematics. The integration value Iₚᵣₑ can be calculated either upon requirement or it is already present in a database.

Likewise, the actual paint consumption aₚᵣₑ for the preliminary version is determined, for example from a database. The start value S for the new learning phase of the current robot program R is then obtained from:
S=I×aₚᵣₑ/Iₚᵣₑ.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### REFERENCE SYMBOL LIST

C correction factor
R robot program
Rₚᵣₑ precursor robot program
I integration value
Iₚᵣₑ precursor integration value
S start value
aₚᵣₑ actual consumption for preliminary version

What is claimed is:

1. Method for determining a required paint quantity for the paint-spraying operation of a paint-spraying robot, comprising the following steps:
a) in an integration operation, from the motional sequence of the paint-spraying robot and the paint-spraying parameters, an integration value (I) for the paint quantity is determined,
b) a correction factor (C) is determined,
c) from the integration value (I) and the correction factor (C), a start value (S) is formed, d) the start value (S) is fed to an adaptive system.

2. Method according to claim 1, wherein prior to the formation of the start value, a decision is taken which relates the paint-spraying operation to predating paint-spraying operations, the paint-spraying operation being either:
i) merely a modification of some preceding paint-spraying operation or
ii) a new paint-spraying operation.

3. Method according to claim 2, wherein in case i) the correction factor (C) is determined from the actually required paint quantity of the preceding paint-spraying operation.

4. Method according to claim 3, wherein the correction factor (C) is determined from the actually required paint quantity and the paint quantity, calculated in an integration operation, of the preceding paint-spraying operation.

5. Method according to claim 2, wherein, in case ii), the correction factor (C) is determined manually.

6. Method according to claim 4, wherein the correction factor (C) is formed as a quotient of the two paint quantities.

7. Method according to claim 1, wherein in step b) the desired motional values of the paint-spraying robot are adopted as the working basis, without regard to the kinematics.

8. Use of a method according to claim 1 to operate a paint-spraying robot containing filled paint cartridges.

9. Use of a method according to claim 1 to operate a paint-spraying robot containing a paint pipeline divided by stoppers.

10. Method according to claim 6, wherein in step b) the desired motional values of the paint-spraying robot are adopted as the working basis, without regard to the kinematics.

11. Use of a method according to claim 7 to operate a paint-spraying robot containing filled paint cartridges.

12. Use of a method according to claim 7 to operate a paint-spraying robot containing a paint pipeline divided by stoppers.

13. Method for determining a required quantity of a spray liquid for a robot spraying operation, comprising the following steps:
a) an integration value (I) for the liquid quantity is determined based on a motional sequence of the robot and spraying parameters,
b) a correction factor (C) is determined,
c) a start value (S) is determined based on the integration value (I) and the correction factor (C), and
d) the start value (S) is fed to an adaptive system.
